(19) United States
(12) Patent Application Publication
(10) Pub. No.: US 2021/0157813 A1
(43) Pub. Date: May 27, 2021

(54) MUTUALLY EXCLUSIVE SEARCH OPERATIONS

(71) Applicant: MicroStrategy Incorporated, Vienna, VA (US)

(72) Inventors: Abdelrahman Hammad, College Park, MD (US); Victor Pena, Falls Church, VA (US)

(21) Appl. No.: 17/102,996

(22) Filed: Nov. 24, 2020

Related U.S. Application Data
(60) Provisional application No. 62/940,938, filed on Nov. 27, 2019.

(51) Int. Cl. G06F 16/2453; G06F 16/2455

(52) U.S. Cl. CPC G06F 16/24532; G06F 16/24553

(57) ABSTRACT

Methods, systems, and apparatus, including computer-readable media, for generating mutually exclusive results from search operations. In some implementations, a query term is received. Multiple queries are generated based on the query term, the multiple queries are generated to include criteria such that the multiple queries respectively yield mutually disjoint sets of results. The multiple queries are processed in parallel. A set of results for each of one or more of the multiple queries are received. The set of results for each of the one or more of the multiple queries are provided.

### CROSS-REFERENCE TO RELATED APPLICATIONS

This application claims the benefit of U.S. Provisional Patent Application No. 62/940,938, filed on Nov. 27, 2019, the entire contents of which are incorporated by reference herein.

### TECHNICAL FIELD

This specification relates generally to performing search operations, and more particularly, to performing search operations that generate mutually exclusive results.

### BACKGROUND

Many search-based applications identify and rank search results based on relevance to a query. This process of identifying and ranking results is often simple for small data sets, but becomes more complex when using large datasets or when large numbers of results are returned. As an example, a database system may provide results to a query, but additional processes to evaluate and rank the results and prepare the results for presentation to a user. In many systems, the amount of processing required and the delay perceived by the user often increase as the number of results increases. The perceived delays may be greater when searches are performed by user devices (e.g., desktop computers, laptop computers, tablet computers, mobile phones, etc.), which often have limited processing resources. If results are not shown to the user until all of a large set of results are individually ranked, the delay in providing results to the user may be unacceptable.

### SUMMARY

In some implementations, a system provides search functionality that can receive a user input and generate multiple queries that are formed to yield mutually exclusive sets of results. The system can use the multiple queries to improve the speed of searching and to reduce the computational complexity of ranking, which allows the system to provide results to the user more quickly. The system can process the multiple queries in parallel, allowing the searches for the different queries to return results asynchronously with respect to each other. This can reduce the amount of time required to provide results to the user, because an initial set of results can be provided as soon as just one of the multiple searches returns results. The fact that the queries return disjoint sets of results allows the queries to be run in parallel with no dependencies on each other. In addition, it ensures that the results of each query are unique. These characteristics can significantly reduce the computation and time required to rank the results. For example, each set of results from the multiple queries can be provided as a group, without the need to intersperse results from different queries. For example, a first set of results for a first query can be provided, and then a second set of results for a second query are provided beneath the first results. In this manner, the individual results from one query do not need to be ranked relative to results for other queries, because each query's set of results can be provided as a group. Also, because the sets of results are disjoint by design (e.g., by virtue of the criteria of the queries), there are no duplicate results and thus no need to perform processing to find and remove any duplicate results. These aspects and others discussed below can greatly improve the speed and efficiency of searching.

As an example, the system can receive a search term from a user's search query, and the system can generate multiple queries to process based on the search term. The system can process the multiple queries in parallel and provide results to the user based on the sets of results obtained for the multiple queries. In some implementations, the multiple queries are generated based on a query template and the search term. The query template can define the rules associated with each query of the multiple queries. For example, the query template can define that a first query return search results that exactly match to the received search term. The query template can define that the second query can return search results that match to a portion of the received search term, e.g., the search term matches to a beginning portion of the search results, and that the second query's search results do not include any search results generated from the first query.

In some implementations, the multiple queries are said to be mutually exclusive or disjoint from one another. Additionally, the query template can determine a number of search queries to generate in response to the system receiving the search term. For example, the query template can indicate that the system generate more than two search queries, such as ten or thirteen queries. Each of the generated queries, when processed, will generate results that are mutually exclusive from one another. In response to retrieving each set of search results from the multiple search queries, the system can provide each set of search results in a ranked order to display.

In some implementations, the system also includes a ranking template that defines a predetermined ranking order for search results that correspond to a particular query. The predetermined ranking order defines a location to place each set of search results on a particular display. For example, after the search results associated with a particular query, such as a first query, are received, the system determines a location for providing the corresponding results on display. Additionally, after the system receives search results associated with another query, such as a second query, the system determines another location for providing the corresponding results on display. The system looks up the location for placement of the search results based on the query in the ranking template. For example, the system determines from the ranking template that results received from the first query should be placed ahead of results received from the second query on the display. The ranking template can define a location for a set of results associated with a particular query based on a type of a query, a relevance of the query to a particular user, and a context of the search results, to name a few examples. A user can modify the query template and the ranking template to modify the queries and preferences associated with ranking, respectively.

In some implementations, the search technique can be performed on a client device. For example, the client device can execute the search technique on stored or cached data. The client device can receive from a database periodically or in response to a request. The search technique, operating on the client device, can receive a search term of a search query, generate the multiple search queries based on the search term, and process the multiple search queries over the cached data stored on the client device. In some implementations, the client device can index the cached data to speed up the processing of the multiple search queries.

In a general aspect, a method includes: receiving, by the one or more computers, a query term; generating, by the one or more computers, multiple queries based on the query term, wherein the multiple queries are generated to include criteria such that the multiple queries respectively yield mutually disjoint sets of results; processing, by the one or more computers, the multiple queries in parallel; receiving, by the one or more computers, a set of results for each of one or more of the multiple queries; and providing, by the one or more computers, the set of results for each of the one or more of the multiple queries.

Implementations may include one or more of the following features. For example, in some implementations, wherein receiving a set of results for each of one or more of the multiple queries includes: receiving a first set of results for a first query of the multiple queries; and receiving a second set of results for a second query of the multiple queries; wherein providing the sets of results comprises providing the first set of results and the second set of results ranked according to a predetermined priority of the first query with respect to the second query.

In some implementations, providing the set of results includes providing the set of results for display in a user interface, the set of results from each query being grouped together, with the groups ordered according to the ranking.

In some implementations, the method includes each of the multiple queries is based on the query term, such that each of the multiple queries includes criteria requiring a match to at least a portion of the query term.

In some implementations, the method includes at least some of the multiple queries have criteria corresponding to different levels of similarity with the query term or different degrees of match with the query term; and wherein the sets of results are ranked according to the different levels of similarity with the query term or the different degrees of match with the query term.

In some implementations, receiving a set of results includes receiving a first set of results for a first query of the multiple queries; wherein providing the set of results comprises displaying the first set of results; wherein the method includes: after displaying the first set of results, receiving a second set of results for a second query of the multiple queries; accessing data indicating a predetermined ranking of the second set of results with respect to the first set of results; and displaying the second set of results at a location determined based on the predetermined ranking.

In some implementations, the method includes the predetermined ranking specifies that results from the second query are ranked higher than results from the first query; and wherein displaying the second set of results includes inserting the second set of results above the first set of results that were previously displayed.

In some implementations, the method includes: obtaining the sets of results for the multiple queries asynchronously with respect to each other; and providing updated search result information for display in response to receiving each of the sets of results, wherein the sets of results are organized in groups that are ranked based on the respective queries that yielded the sets of results.

In some implementations, each of the multiple queries includes mutually exclusive criteria, and wherein processing the multiple queries includes identifying results for each of the multiple queries in a same data set.

In some implementations, generating the multiple queries includes generating a series of queries in which (i) each of the query in the series includes one or more positive criteria indicating a characteristic required to satisfy the query, and (ii) the second and subsequent queries in the series each include one or more negative criteria that exclude the characteristics of the positive criteria of each of the previous queries in the sequence.

In some implementations, the multiple queries include: a first query that includes one or more first criteria based on the query term; and a second query that includes (i) one or more second criteria based on the query term and (ii) a limitation to exclude results that meet the one or more first criteria.

In some implementations, the multiple queries further include a third query that includes (i) one or more third criteria based on the query term, (ii) a limitation to exclude results that meet the one or more first criteria, and (iii) a limitation to exclude results that meet the one or more second criteria.

In some implementations, the method includes at least some of the multiple queries are configured to require different types of matches to the query term, including at least one of an exact match, a partial match, a prefix match with an initial portion of the query term, a suffix match with an ending portion of the query term, a fuzzy match, or a phonetic match.

In some implementations, the method includes at least some of the multiple queries require matching at least a portion of the query term to different portions or fields in a data set.

In some implementations, processing the multiple queries in parallel includes running the queries such that sets of results for the multiple queries are received asynchronously independent each other.

In some implementations, generating multiple queries includes generating a predetermined number of queries based on a predetermined set of query templates, the query templates each having a predetermined ranking or priority with which to order sets of results responsive to queries derived from the respective query templates.

In some implementations, communicating, by a computing device, with a server system to update contents of a local cache of the computing device; and generating, by the computing device, an index based on the updated contents of the cache; wherein processing the multiple queries includes using the index identify content from the cache that is responsive to the respective multiple queries.

In some implementations, the method includes: the receiving the query term, the processing, the generating, the receiving the set of results, and the providing are performed by a mobile computing device.

Other embodiments of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example of a system for performing a search to generate mutually exclusive sets of search results.

FIGS. 2A-2C illustrate examples of user interfaces illustrating search results being displayed in a ranked order.

FIG. 3 is a block diagram that illustrates an example of a system for generating multiple queries based on a query template.

FIG. 4 is a flow diagram of an example process for executing a search technique that generates mutually exclusive search results in response to receiving a search term from a search query.

Like reference numbers and designations in the various drawings indicate like elements.

### DETAILED DESCRIPTION

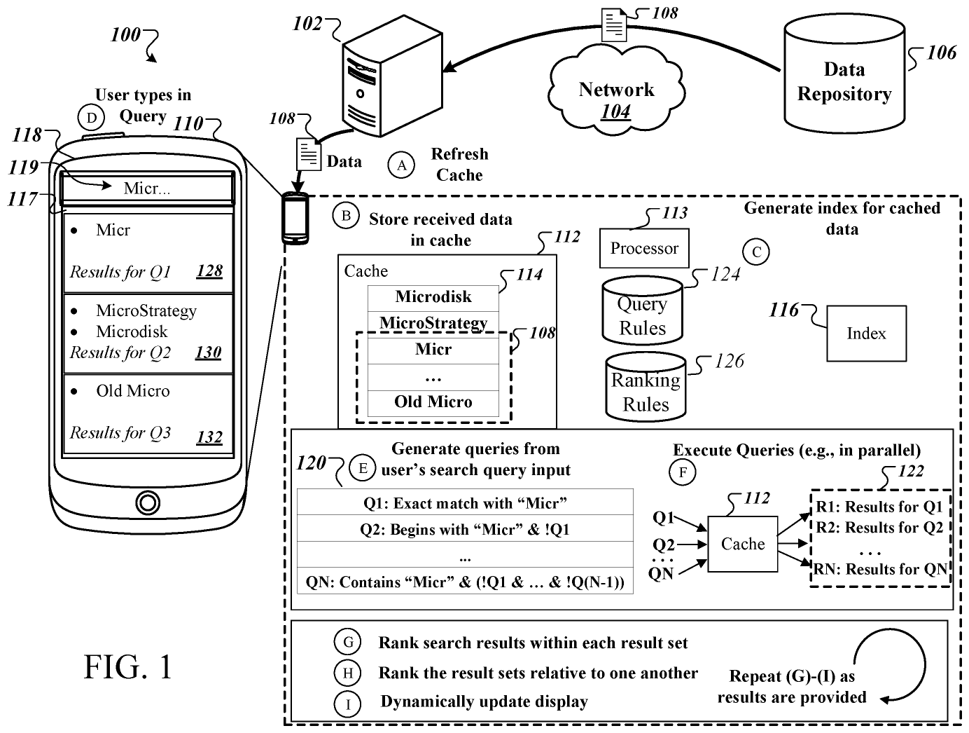

FIG. 1 is a block diagram that illustrates an example of a system 100 that can generate mutually exclusive sets of search results. The system can receive a search query or a portion of a search query, and generate multiple queries defined to provide mutually exclusive results. As discussed further below, the multiple queries can be used in parallel to quickly generate search results, and the mutual-exclusivity of the result sets can facilitate fast and efficient ranking and presentation of results to a user.

The system 100 includes a server 102, a network 104, a data repository 106, and a client device 110. The client device 110 includes a cache 112 (e.g., which may be stored in a memory or other data storage), at least one processor 113 (e.g., a central processing unit (CPU)), and data storage that includes a query rules 124 and a ranking rules 126. In some implementations, these components may be operated and managed by a single party, such as a user, or an organization, for example, as part of a searching platform. For example, the client device 110 may operate with the server 102 and the data repository 106 in a business intelligence platform or a consumer platform by responding to queries and displaying results in a public or a confidential environment. FIG. 1 shows various actions, marked as stages (A) to (I), which can be performed the order indicated or in another order.

The example of FIG. 1 shows various actions that are performed to prepare to perform search operations and to carry out search operations at a client device 100. The example shows local searching performed by the client device 110 to search a data set stored at the client device 110 (e.g., in the cache 112). Nevertheless, the same search techniques can be used in other configurations and with other devices. For example, the client device 110 may use the technique of generating and issuing multiple queries with mutually exclusive result sets to issue a set of queries to a search engine, database server, or other device, such as to a remote server over the network 104. As another example, a server system (e.g., a search engine or database server) may receive a natural language query and generate multiple queries with mutually exclusive result sets in order to generate results to then provide to a client device.

In the example of FIG. 1, the client device 110 receives, stores, and indexes data for a cache 112 or other data storage of the client device 110. When a user enters a search query 119, the client device 110 generates multiple queries 120, labeled Q1 to QN, based on the user's search query 119. The generated queries 120 are defined so that each query produces a disjoint set of results. In other words, even though the queries 120 are used to search over the same data set, the queries 120 include criteria to require the result sets to be mutually exclusive. As a result, the search result sets produced using the respective queries 120 will not overlap and no deduplication of results is needed.

Searches are performed using each of the various queries 120 to generate separate result sets for each query, e.g., result set R1 includes results from query Q1, result set R2 includes results from query Q2, etc. The queries 120 can be processed asynchronously and/or in parallel with respect to each other, with no dependencies on each other. As results are obtained from the various queries 120, the results within each result set are ranked, and the result sets are ranked relative to each other. The ranking of the result sets can be performed according to a predetermined ranking or hierarchy, e.g., with results from the queries 120 being ranked according to a predetermined order R1, R2, . . . , RN. As new result sets are obtained, the user interface can be updated by inserting the new result sets in their appropriate positions in the predetermined order. This can facilitate very fast initial display of results to a user, because the results from any of the queries 120 can be displayed as soon as they are obtained, without waiting for processing of any of the other queries 120 to be completed. In addition, as higher-ranked sets of results are obtained (e.g., from queries 120 corresponding to a higher priority) the new result sets can be inserted in the display with minimal processing.

In the system 100, the client device 110 performs a search technique that involves executing multiple queries. The client device 110 provides a user interface (UI) 117 for accepting queries. For example, the user interface may include a search query field that allows text entry. The user can interact with the UI of the client device 110 by typing in a query, speaking a query, or otherwise entering a query. The query can include one or more search terms, such as a word, a phrase, or a letter. The search technique can be used with complete queries (e.g., once a user submits a query and considers it complete) and/or partial queries (e.g., portions of queries, even partial words, and potentially before a user indicates that the query should be processed). In response to the entry of the search query, the client device 110 obtains and presents search results in a ranked fashion to facilitate reviewing search results.

The client device 110 is configured to generate multiple queries to be processed for each search query that a user enters. In other words, a search term entered by a user may result in multiple different search query variations being generated in order to fulfill the user's request. For example, consider a case where a user enters the term “first” to the client device 110. As the user types in the word “first,” the client device 110 generates multiple queries based on the term “first.” In some implementations, the client device 110 determines the number and/or types of queries to generate based on a query template. The query template indicates a number of queries to generate and a rule for generating query. For example, a first query searches for results that exactly matches to the word “first.” A second query can be a suffix search (e.g., searches for results having a term that ends with the character string “first”) that excludes results that are have exact word match. A third query can be a prefix search (e.g., searches for results having a term that begins with the character string “first”) that excludes results that have an exact word match. A fourth query searches for results having a term that includes the character string “first” but excludes results that have an exact word match, a prefix match, or suffix match. Thus, the generated queries return sets of search results that are mutually exclusive or disjoint from one another.

By generating results that are mutually exclusive, the client device does not return duplicative results. By ensuring the results are mutually exclusive, each result will only be produced once and associated with one of the generated queries, even though the queries are searching over the same corpus of data (e.g., the same index, the same set of documents, the same cache, etc.). In this manner, the search queries can be executed in parallel with no dependencies on one another. Additionally, the results of each query are unique.

In some implementations, the client device 110 places the search results in a particular location on the display. The client device 110 uses a ranking template to determine the relative position of the search results. For example, the ranking template can indicate that the search results obtained using the first query are ranked above (e.g., placed ahead of) search results obtained using the second query. Further, the ranking template can indicate that the search results obtained using the second query should follow the search results obtained using the first query and precede the search results obtained using the third query. Consequently, the sets of search results corresponding to the respective queries are placed in a ranked manner on the display. In some implementations, a user can adjust the preferences within the ranking template to rearrange the order of the displayed results. For example, the user can adjust the preferences such that the ranked results that are most relevant appear first on the display. In general, the results from the most restrictive query, e.g., the one that most closely matches to the user's query terms, are ranked highest.

The client device 110 will dynamically update the display with new results as results from other queries are obtained. For example, the client device 110 can initially generate a set of results using the second query and place that result set at the top of the results area. Then, the client device 110 may later obtain a set of results using the first query, e.g., because the first query may require more time to complete processing. The client device 110 can determine from the ranking template that the results associated with the first query should be ranked above the results from the second query. In response, the client device 110 can place the results from the first query above the previously displayed results of the second query, e.g., by inserting the results from the first query at the top and moving down the results from the second query. Additionally, results from the third query may be generated later. The client device 110 can determine from the ranking template that results associated with the third query are ranked below the results from the first and second queries. Thus, the client device 110 places the results from the third query below the results of the first and second query on the user interface.

In some implementations, the results from each query are generated in parallel and/or asynchronously. Thus, the client device 110 timing at which the results from different queries can be obtained is variable and not guaranteed. In this case, the client device 110 dynamically updates the user interface 117 with the newly obtained search results from each query as the results are obtained.

In some implementations, the search process can be repeated as the user types. For example, as the user updates the search query by typing new characters or words, a new search can be initiated and new results provided as the user types. As an example, after typing the term “first” the user can then type in the next search term of the search query, e.g., “data.” The system will then generate multiple queries from the “first data” search query, generate search results corresponding to each of multiple generated queries, and dynamically update the user interface 117 of client device 110 with the generated search results. The search results from both search terms can be combined on the display in a ranked fashion, as previously discussed.

The example of FIG. 1 shows a user interacting with the client device 110 in a manner that generates requests and obtains search results from the client device 110's cache 112. The user can additionally or alternatively interact with another client device, separate from the client device 110, to perform a search on the client device 110. The other client device can communicate with the client device 110 over network 104. FIG. 1 illustrates various operations in stages (A) through (I), which illustrate a flow of data that can be performed in the sequence indicated or in another sequence.

The client device 110 can be, for example, a desktop computer, a laptop computer, a tablet computer, a wearable computer, a cellular phone, a smart phone, a music player, an e-book reader, a navigation system, a smart speaker, an appliance, a digital assistant device, or any other appropriate computing device. The network 104 can be wired or wireless or a combination of both, and can include the Internet.

Initially, the client device 110 obtains data to be stored. During stage (A), the client device 110 receives data from a server 102. The server 102 can be a single computer or multiple computers connected over a network. In some implementations, the client device 110 can send a request to the server 102 for additional data.

In some implementations, the client device 110 can periodically receive updates with new data from the server 102. The server 102 can provide updates of data to the client device 110 on a periodic basis, such as, every day, week, or month, to name a few examples. The data 108 that is received may include documents, data sets, media, text, and other types of data. In some implementations, the server 102 sends data 108 that is predicted to be of interest to the user of the client device 110, e.g., documents frequently accessed by the user, documents used by the user on other devices, documents related to topics of interest to the user, etc. In some implementations, the data 108 can represent data (e.g., documents, files, etc.) that are provided in response to requests by the client device 110, and the client device 110 stores the received data for later use.

The server 102 can retrieve data from a data repository 106 over network 107. The data repository 106 can include varying types of data such as, for example, business data, financial data, and medical data. The various types of data can be displayed in the format of table data, media, graphs, uniform resource locator (URL) links, documents, text, and other displayed forms. The server 102 can send a request to the data repository 106 in response to receiving a request from the client device 110 for data. In some implementations, the server 102 can automatically request for data from the server 102 and push down data to the client device 110 on a periodic basis. Each time the server 102 provides data to the client device 110, the server 102 can store a copy of the data so it has knowledge of data currently stored on the client device 110. The server 102's stored copy enables the server 102 to only provide new data to the client device 110 from the data repository 106, thus, reducing redundancy of information stored on the client device 110.

As shown in FIG. 1, the server 102 retrieves data 108 from the data repository 106 over network 104. The server 102 then provides the data 108 to the client device 110.

During stage (B), the client device 110 receives the data 108 and stores the received data 108 in its cache 112. In some implementations, the cache 112 can include data contents 114. The data contents 114 can include previously received data from the server 102 and/or from other sources, including data generated by the device 110. As illustrated, the received data 108 is appended to the data contents 114 in the cache 112, or can replace data in the cache 112. In some cases, the client device 110 interleaves the received data 108 throughout the cache 112. By storing data in a fast retrieval memory, such as cache 112, a processor 113 of the client device 110 can quickly and effectively process queries for retrieving data from the cache 112.

During stage (C), the client device 110 can perform indexing on the data in the cache 112 to generate an index 116. By indexing the data in the cache 112, the performance of retrieving information from the cache 112 can be improved. In particular, the data in the cache can be more effectively searched. In some implementations, the cache 112 can include a large number of data areas (e.g., rows, tables, etc.) and can be indexed with a hash function or a binary coding scheme. The hash function can reference a particular row or table in the cache 112. In other examples, the cache 112 can be indexed with a numbering scheme that references a particular data element in a row or table of the cache 112. The processor 113 can use the index 116 to perform a search over the contents of the cache 112.

During stage (D), the client device 110 receives a query 119 from a user. The query 119 can include one or more search terms. The client device 110 includes a display 118 or other interface that enables a user to input the one or more search terms of the query 119. For example, a user may type on an on-screen keyboard shown on the display 118 of the client device 110. In another example, a user may type on a physical keyboard on the client device 110 to enter the query. In yet another example, a user may speak the query 119 to the client device 110, which may detect the audio with a microphone and obtain text using an automatic speech recognizer. In the illustrated example, the user enters the search term “Micr” as the initial portion of a search query, such as “MicroStrategy.”

The user interface 117 includes a search query entry field that displays the one or more search terms of the search query 119 entered by the user. The client device 110 can dynamically update a display of the search query entry field to show the search terms as the user enters the search terms.

During stage (E), the client device 110 generates multiple queries 120 from the search query 119. In response to receiving the search query 119, the client device 110 can use the query rules 124 (e.g., query generation rules) to determine a number of queries 120 to generate and types of queries 120 to generate. In some implementations, the query rules 124 can be stored in the memory of the client device 110. In some implementations, the query rules 124 can be stored external to the client device 110.

The query rules 124 can indicate the number of queries 120 to generate and the rules of each generated query in a template. In some example, the query rules 124 can include multiple templates. In some implementations, a template may define characteristics for multiple queries 120, with each query having a particular rule and a field for entering the search term. For example, a particular template defines three queries 120. In another example, the query rules 124 includes a particular template that defines how to generate thirteen different queries. The client device 110 can select which template to use based on a predefined selection. The predefined selection can be based on, for example, user preference, heuristics showing which template typically produces the greatest number of search results, and a standard template.

In some implementations, the client device 110 retrieves the template from the query rules 124 and uses the template to generate the queries 120. For example, a template may include two search query definitions that recite: “Q1—match whole word (term)” and “Q2—partial match (term) & !Q1”. In the example of FIG. 1, with the search term “Micr” provided by the user, the client device 110 can replace the placeholder “term” with the term or phrase entered by the user. As a result, the generated queries 120 would include “Q1—match whole word (Micr)” and “Q2—partial match (Micr) & !Q1.”

Some query definitions may operate on a single term and some based on multiple terms. For example, one query definition may require that all terms occur in a result, and another query definition may require that only one of multiple terms occur in a result. The client device 110 may omit the generation of queries based on query definitions that do not fit the nature of the user input. For example, if a query definition requires multiple terms and only one term is provided, the client device 110 can skip generating a query based on that query definition.

In some implementations, the query definitions in the template are structured to include criteria that enforce mutual exclusivity between the sets of results of each query 120. In some implementations, the mutual exclusivity is achieved by one or more queries 120 including a criterion that specifically excludes items that would match one or more of the other queries 120. Queries 120 can include selection criteria and exclusion criteria. The selection criteria can indicate the features or characteristics that would qualify data to be selected as satisfying the query, e.g., defining an initial set of what constitutes a match for that query. The exclusion criteria enforce the mutual exclusivity with respect to one or more other queries 120. For example, the exclusion criterion can require that, for a particular query 120, any matches cannot meet the selection criteria of one or more other queries 120.

Continuing with the example from above, the first query definition includes a selection criterion requiring a whole word match (e.g., an exact match). The second query definition sets for a selection criterion requiring only a partial match (rather than a whole word match), and also includes an exclusion criterion “!Q1” which represents that results to query Q2 must exclude results that satisfy the selection criteria for query Q1. This may be expressed as a In a similar manner, the third query definition in the template may specify different selection criteria, and include exclusion criteria to exclude results that meet the selection criteria for Q1 and Q2 (e.g., a requirement of !Q1 and !Q2). Other number of queries is also possible. By ensuring that each of the queries are mutually exclusive, (1) each of the queries can be executed in parallel with no dependencies on one another; and (2) the results of each query is unique, and thus, independent from the results of the other queries.

In the illustration, the query Q1 is “Exact match with ‘Micr,’” meaning that it requires a matching item to include a term that is an exact match with the term “Micr.” The query Q2 is “Begins with ‘Micr’ & !Q1”, meaning that a matching item begins with the term “Micr” and that that the results cannot satisfy query Q1. Query Q2 may be equally stated as requiring a term that “Begins with ‘Micr’ and is NOT an Exact match with ‘Micr.’”

In some implementations, queries 120 can include a range of different strictness of match to query terms. These can be ordered from strictest to least strict, e.g., exact phrase match, requiring all query terms present, requiring any one of the query terms present, requiring a prefix match or suffix match, containing a character sequence for a term anywhere, a fuzzy match or phonetic match (e.g., a soundex match), etc. Each of the queries in this manner can include exclusion criteria to exclude each of the selection criteria for the queries earlier in the list, so that broadening the match does not bring in results that were already included in a narrower query. This is not the only way to enforce exclusivity of results, of course, and exclusion of results does not require separate exclusion criteria.

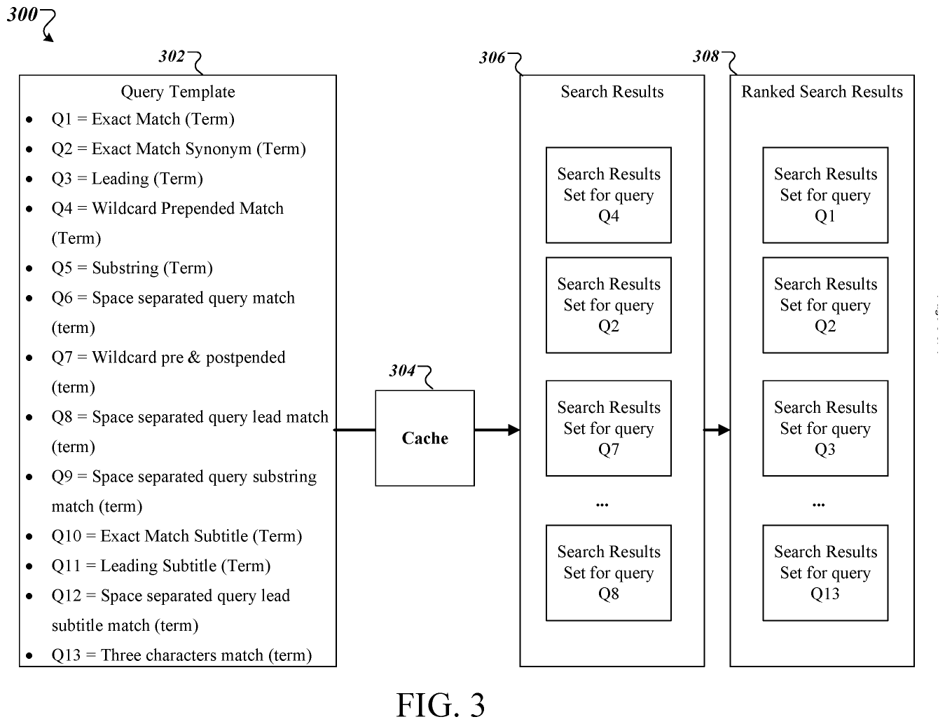

In some implementations, a user can edit the rules associated with templates in the query rules 124. Moreover, a user can edit each query in the query rules 124 to adjust the rules of each query. For example, a user can change the rule associated with the second query. The rule can be changed from search results beginning with the search term to search results ending with the search term. In another example, the user can change the rule associated with the third query from search results containing the search term to search results that contain metadata that contain the search term. In another example, the user can edit the template by reducing or adding queries to the template. In other examples, the user can add new templates with different queries to the query rules 124. Other types of queries will be described with respect to FIG. 3.

As shown in FIG. 1, the client device 110 selects a template that has N number of queries definitions, where Nis a positive real number. By inserting the search term “Micr” into the appropriate fields of the query definitions, the client device 110 generates N queries 120. For example, in template, query Q1 is a query seeking results having an exact match to the search term. Query Q2 is a query seeking results that (i) include a term that begins with the search term (e.g., include “Micr” as a prefix) and (ii) do not include an exact match to the search term (e.g., exclude any results identified by query one). Query N is a query seeking results that contain the search term and do not include any results identified by any of the other queries 120.

During stage (F), the client device 120 executes each of the queries, e.g., Q1, Q2, . . . QN, over the data in the cache 112 in parallel. In this example, and in some implementations, all of the queries 120 can be used to search over the same data set or corpus of information (e.g., the same documents or cached data). In other words, the exclusivity among the result sets occurs due to the difference in the criteria of the respective queries 120, not because the queries 120 were applied on different restricted sets of data.

When the queries 120 are executed, the processor 113 searches for data in the cache 112 that meet the requirements set forth by the rules of the respective queries 120. Multiple data fields or portions of data in the cache can be searched. For example, the processor 113 can search at least one of content, metadata, body, title, author, heading, category, subtitle, annotations, and/or comments associated with the data in the cache 112. In some implementations, processing each of the queries 120 involves searching using the index 116 to identify content from the cache 112 responsive to the respective queries 120. If the processor 113 finds data in the cache 112 that matches a requirement of a particular query based on the index 116, the processor 113 returns the data as a result for that particular query 120. The server performs the search process for each query 120 generated based on the template.

In some implementations, the processor 113 executes the multiple queries 120 from the template so that the sets of results for the multiple queries 120 are received asynchronously. For example, the queries 120 can be processed concurrently, and the sets of results for the respective queries 120 are received independently from one another and at different times. Additionally, the query criteria for the queries 120 enforces the mutual exclusivity between each set of results. As a result, carrying out the search as indicated by the exclusion criteria ensures the set of results R1 associated with query Q1 are not included in the set of results R2 associated with query Q2.

During stage (G), the client device 110 ranks the search results within each set of results R1 to RN. In other words, the results in result set R1 are ranked with respect to each other, the results in result set R2 are ranked with respect to each other, and so on. The processor 113 analyzes and ranks the search results according to criteria retrieved from the ranking rules 126. The ranking rules 126 can be stored internally on the client device 110. In some implementations, the ranking rules 126 can be obtained from a source external to the client device 110.

The ranking rules 126 can indicate that the search results within a particular result set are to be weighted according to predefined criteria. For example, the predefined criteria can include a relevance of results to the user, a context of the search results, popularity of the search results for other users, alphabetic order by a certain field (e.g., title, author, etc.), and so on. If the processor 113 ranks a search result with a high weight for a particular predefined criteria, the higher the likelihood that the user will select that particular search result. For example, a user can define in the ranking rules 126 that the relevance of results corresponds to a particular business. Consequently, when the processor 113 receives results for query three, e.g., contains the search term, any result not relating to a particular business will be assigned a lower weight. For example, the processor 113 receives three results for query three that include the phrases “MICROSOFT,” “MICRO STRATEGY,” and “microunit.” The processor 113 assigns the search results of “MICROSOFT” and “MICROSTRATEGY” with a higher weight than the search result of “microunit” because the former search results relate to businesses while the latter search result does not. Continuing with this example, the processor 113 ranks the search results in the order of “MICROSTRATEGY” with a weight of 80%, “MICROSOFT” with a weight of 70%, and “microunit” with a weight of 10%. In some implementations, the weights for each search result within a set do not have to add to 100%.

In some implementations, the processor 113 performs applies weights to each search result within a set of search results generated from each query. The processor 113 ranks each of the search results within a result set. This step does not involve or require ranking of results between sets, which maintains that ability to present the result sets independent of each other.

During stage (H), the client device 110 ranks the result sets R1 to RN relative to one another. In some implementations, the ranking rules 126 include a predefined ranking of the result sets. For example, before the queries 120 are even generated or executed, the ranking rules 126 can define that results from query Q1 are ranked first, results from query Q2 are ranked second, results from query Q3 are ranked third, and so on. As a result, ranking result sets R1 to RN relative to each other can be simply ordering the result sets that have been obtained so far in the predetermined order. The processor 113 retrieves the data from the ranking rules 126 that indicate how the result sets are to be ranked. For example, the processor 113 determines that the result sets corresponding to the first query are ranked higher than the result sets corresponding to the second query. However, the result sets corresponding to the third query are ranked higher than the result sets corresponding to the first query and the second query. Other rankings are also possible and are left open to the implementation of the system designer.

In some implementations, the processor 113 determines that the ranking rules 126 indicates that certain results have a predetermined ranking. For example, the ranking rules 126 can indicate that search results that exactly match to the search term are ranked higher than search results that just contain the search term. In another example, the ranking rules 126 can indicate that search results leading with the search term are ranked higher than search results that end with the search term.

These predetermined rankings enable the search system to display search results in a particular location on the display. In some implementations, displaying search results in a particular location on the display enable a user to efficiently review search results. For example, a user can review certain portions of the display 118 to see relevant search results or search results that relate to a particular topic.

In some implementations, the ranking of the result sets relative to each other is not predetermined. For example, the ranking rules 126 may specify that result sets should be ranked according to average relevance score, according to the highest relevance score within the result set, according to the number of results, or other criteria.

During stage (I), the client device 110 dynamically updates the display 118. The user interface 117 of the client device 110 can include predetermined regions or locations for placing search results corresponding to a query. For example, the user interface 117 includes a first section 128, a second section 130, and a third section 132. The user interface 117 can be partitioned with more than three or less than three sections. In some implementations, the user interface 117 can have other partitioned sections not shown unless the user scrolls down or up on the user interface 117.

As the client device 110 generates results from each query 120, the client device 110 updates the user interface 117 with the newly generated results. As mentioned, a set of results corresponding to each query can be received asynchronously and are distinct from other sets of results. For example, the set of results corresponding to the second query and the set of results corresponding to the third query may be generated before the results from the first query are generated. Thus, the client device 110 updates the user interface 117 with the results of the second query and the third query before updating the user interface 117 with the results of the first query.

For example, the results for the second query, e.g., “MicroStrategy” and “Microdisk,” may be generated and provided to the user interface 117. Then, the results for the first query, e.g., “Micr,” are generated and provided to the user interface 117 in the section 128. In doing so, the client device 110 inserts section 128 above section 130. Afterwards, the results for the third query, e.g., “Old Micro,” may be generated and provided to the user interface 117. In particular, the client device 110 determines the results for the third query are to be placed in section 132 below the section 130. The client device 110 then inserts section 132 and the corresponding results below section 130. In other implementations, the set of results for each query are listed on the user interface 117 and not partitioned based on sections of the user interface 117.

In some implementations, the user can continue to type a search term of the query in the user interface 117. For example, the results shown on the user interface 117 can dynamically update as the user types “Micro . . . ” to “Micros . . . ” until the user finishes typing the full search query of “Microstrategy.” The client device 110 dynamically updates the user interface 117 with new search results each time a new search term, e.g., “Micro” or “Micros,” is entered into the search query entry field 119. Thus, the stages (E) and (F) can be repeated each time the user enters a new search term. Consequently, each time stages (E) and (F) are repeated, stages (G) though (I) are also repeated so that the new search results generated during stage (F) are ranked within a set, ranked relative to the other ranked sets, and then dynamically provided on the user interface 117. This process repeats each time the user enters a new search term of the query 119.

Once the search results are provided on the display, a user can interact with the search results. For example, the user can tap on a search result for selection for use the keyboard of the client device 110 to select a search result to view or otherwise use. Selecting a search result enables the user view more details of the search results, such as, additional graphs, figures, description, and/or websites on the Internet that link to the search result. In some implementations, the user can delete a particular search result on the user interface 117.

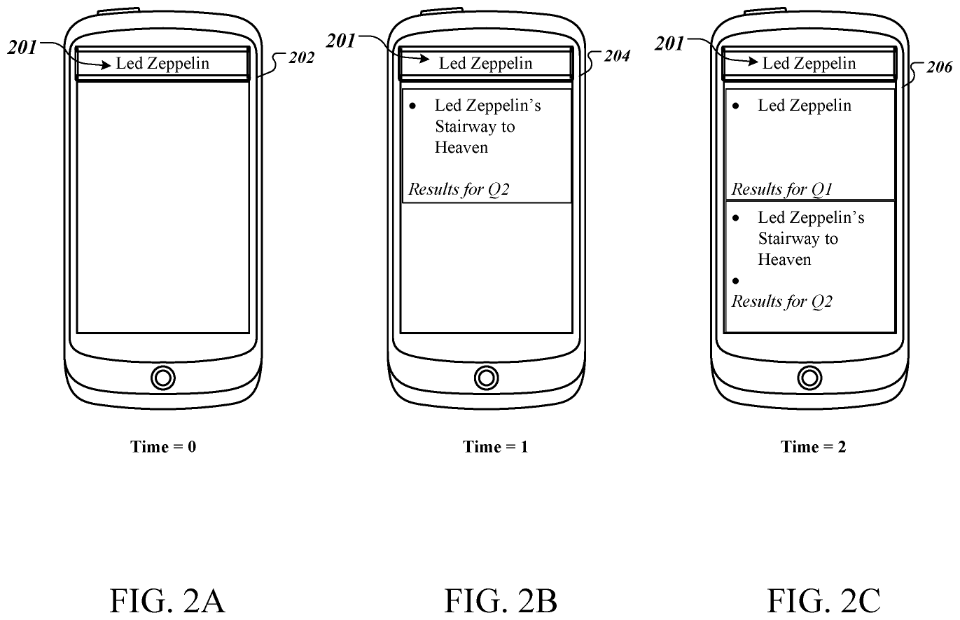

FIGS. 2A-2C are block diagrams that illustrate an examples of search result sets being displayed in a ranked order. The figures show the display at different time steps as the result sets are received for different queries (e.g., Q1, Q2) that are each based on a same user search query 201.

In FIG. 2A, the client device is shown with user interface 202 at time=0. The time is shown in time steps, where each time step can correspond to a particular change of action. In some implementations, the time can refer to a unit of time, such as seconds, minutes, or hours. As shown in user interface 202, a search query 201 has been entered into the search bar of the client device. For example, the search query 201 is “LED ZEPPELIN.” The user enters in “LED ZEPPELIN” by interacting with the client device either by typing on a digital keyboard, providing a voice command, or by typing on a physical keyboard associated with the client device. The user seeks to find search results associated with the search query of “LED ZEPPELIN.”

In FIG. 2B, the client device is shown with user interface 204 at time=1. User interface 204 illustrates a first set of results received for query Q2. In the example, the results for query Q2 are obtained first, so they are presented to the user in the user interface 204. The search process based on query Q1 is still on ongoing at this time, and so has not returned search results to display. The processing of query Q2 returns results that match to the beginning of the search term, contains the search term, or includes wildcard values post-pended to the search term. For example, the search results of query Q2 include “LED ZEPPELIN'S STAIRWAY TO HEAVEN,” and the client device displays the search results at the top of the user interface 204.

As discussed with respect to system 100, the client device generates multiple queries in response to receiving a search query and processes the multiple queries in parallel. As shown in system 200, at least two search queries are generated in response to receiving a query 201 of “LED ZEPPELIN.” The first query Q1 searches for results that match exactly to the search term and the second query Q2 searches for results that match to the beginning of the search term, contains the search term, or match if wildcard values are post-pended to the search term. Additionally, the client device ensures the two queries include mutually exclusive results. For example, the second query can also include the limitation of not including results found in the results of the first query. In another example, the first query can include the limitation of not including results found in the second query. Thus, the results of the first and second queries are disjoint or mutually exclusive.

In FIG. 2C, the client device is shown with user interface 206 at time=2. At this time, the results for query Q1 have been received. In this example, the search results of query one include an exact match to the search term “LED ZEPPELIN.” The client device includes a ranking rule that dictates a location of the result sets, according to the query with which the result set was obtained. For example, the client device determines that the results associated with query Q1 precede the results associated with query Q2. Thus, the search results of query Q1 are placed ahead of the search results of query Q2 that were previously presented. In essence, the search results of query Q2 moves down to allow for the ranked displaying of search results associated with query Q1. Other configurations are possible for the user interface locations of query results.

FIG. 3 is a block diagram that illustrates an example query template 302 and related processing. The figure shows a query template 302, a cache memory 304, search results 306, and ranked search results 308. The figure shows internal processes of a client device performing a search based on one or more search terms.

The client device can receive a query from a user. In response to receiving the query, or a search term of the query, the client device retrieves a query template 302 from the query rules. A query template can include a certain number of queries and a rule associated with each of the search queries. For example, the query template 302 includes thirteen query definitions, so that thirteen different queries would be generated for each user search query. The search term can be inserted into the query definitions of the query template 302, and the client device can process each of the queries over a data set, such as a cache 304. For example, the search term “LED ZEPPELIN” can replace the placeholder “term” in each of the query definitions.

As shown in system 300, the query template 302 includes a first query that searches for results that exactly match to the search term. The second query searches for results that match to one or more synonyms of the search term. The third query searches for results that include the search term as a leading term. The fourth query searches for results that include a wildcard match prepended to the search term. In the fourth query, the wildcard match enables a search result to include any string prepended to the search term. The fifth query searches for results that include the search term as a sub string.

In some implementations, the query template 302 can also include more complex queries. For example, the sixth query separates the search term with space delimiters and searches for results that include one of the space delimited search terms. The seventh query searches for results that include a wildcard match prepended and post-pended to the search term. In the seventh query, the wildcard match enables a search result to include any string prepended and post-pended to the search term.

The eight query separates the search term with space delimiters and searches for results that include one or more of the space delimited search terms as a leading term. The ninth query separates the search term with space delimiters and searches for results that include one or more of the space delimited search terms as a substring. The tenth query searches for results that include subtitles that match exactly to the search term. The eleventh query searches for results that include the search term as a leading term in the subtitles. The twelfth query separates the search term with space delimiters and searches for results that include one or more of the space delimited search terms as a leading term in a subtitle. Lastly, the thirteenth query searches for results that have first three characters match to the first three characters of the search term.

Other types of query rules are also possible, such as a fuzzy match and a phonetic match. A phonetic match can include for example, an exact match of a search term and multiple types of partial matches.

The query template 302 shows the selection criteria for each of the queries Q1 to Q13. Although not illustrated, each of the query definitions can provide exclusion criteria to enforce mutual exclusivity, so that each query generates results that are unique from the results of each of the other queries. In this example, when generating and/or processing each of the queries Q1 to Q13, exclusion criteria can be added for each of the queries earlier in the list. For example, query Q2 includes the requirement “!Q1.” Similarly, query Q5 would include the exclusion criteria “!Q4 & !Q3 & !Q2 & !Q1.” In this manner, the client device enforces the mutual exclusivity rule by enforcing the results to be unique from each other. For example, the results of query two do not include the results from query one. The results of query three do not include the results from query one and query two. Likewise, the results of query thirteen do not include any of the results from query one through query twelve.

In some implementations, the client device uses the user's search term to generate queries based on the query template 302. The client device then processes each of the queries generated using the query template 302 in parallel over the data in the cache 304. The cache memory 304 can have an associated index, which can be used to reduce processing time and increase the rate at which results are generated and subsequently displayed on the client device.

The client device generates search results 306 from each of the queries in the query template 302. In some implementations, the results are generated asynchronously because the queries operate independent from one another. Each search result is grouped in a set according to the corresponding query. For example, a result for query one is generated and stored in search results set one, then a result for query thirteen is generated and stored in search results set 13, then another result for query one is generated and stored in search results set one, and then a result from query two is generated and stored in search results set two. These results for each query are populated and stored in memory.

The client device then retrieves data from the ranking rules to determine how to rank the search results within each set and rank the search result sets relative to each other. For example, the client device ranks the search results within each set based on user preferences, context, and relevance to the user. The client device can also apply weights to each search result within a particular set to rank the search results.

Then, the client device ranks search results sets relative to other search results sets. As discussed above, the result sets can be ranked based on a predetermined rank, according to the query used to generate the result sets. For example, as illustrated, the search result sets were obtained in one order shown in search results 306, but when ranked the search result sets are placed in order according to the query that yielded the result sets, e.g., in order from results from query Q1 to results from query Q13. The client device displays the ranked search results 308 on its display. As more search results are generated for a particular query, the client device dynamically updates its user interface with the new search results on a location of the user interface corresponding to the query.

In some implementations, the search results provided on the user interface of the client device are clickable links. A user interacting with the client device can select a particular search result by tapping on the search result or selecting the search result by interacting with the digital or physical keyboard of the client device. For example, the search result can include a URL link, a link to a database in the data repository, or link to data stored on another client device. The user can then decide whether to interact with another search result, delete a search result, or perform another search.

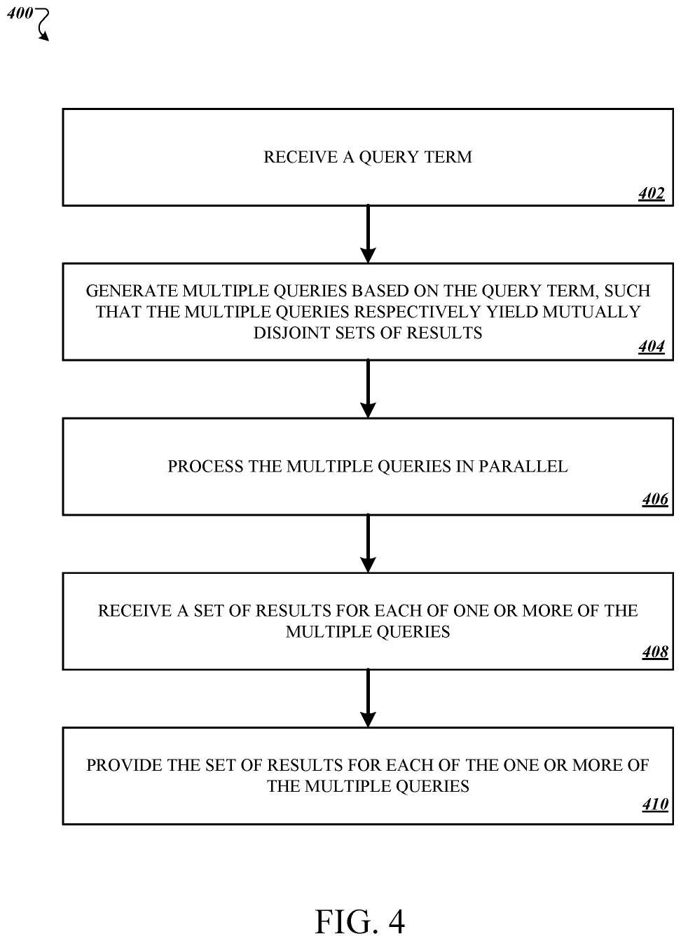

FIG. 4 is a flow diagram of an example process 400 for performing a search. The process 400 can be performed by a client device, such as client device 110 described with respect to FIG. 1.

A client device receives a query term (402). The query term can include one or more search terms. The client device can receive the query term in response to the user inputting the one or more search terms of the query term. For example, the user may verbally provide the query term or type in the query term at the client device.

The client device generates multiple queries based on the query term, such that the multiple queries respectively yield mutually disjoint sets of results (404). In particular, the client device retrieves query data from a query rules that indicates a number of queries and types of queries to generate. The query rules can either be stored on the client device or stored external to the client device.

For example, the query rules can provide a query template for the client device to use for generating the queries. The client device can provide the search term to the query template to generate the queries associated with the query template. For example, the query rules stores a query template that includes three search queries: “Q1—match whole word (term),” “Q2—partial match (term) and not Q1” and “Q3—contains (term) and not Q1 and not Q2.” In some implementations, the query template includes more than or less than three queries. Additionally, each of the queries may include different rules. For example, the client device can provide the query term “math equation” to the query template that results in the following three queries: “Q1—match whole word (math equation),” “Q2—partial match (math equation) and not Q1” and “Q3—contains (math equation) and not Q1 and not Q2.”

In some implementations, each query in the template includes a mutual exclusivity rule to ensure the results of each query are unique, e.g., mutually exclusive or disjoint. For example, the first query searches for results that provides matches to the whole word term. The second query searches for results that partially match to the first term and does not include any results from the first query. The third query searches for results that contain the term and do not include any search results from the first query and the second query. A user can edit these query rules and edit the rules associated with each of the query templates stored in the query rules.

The client device processes the multiple queries in parallel (406). The client device executes each of the multiple queries, e.g., Q1, Q2, and Q3, over the data stored in the cache memory of the client device in parallel. The execution in parallel can be performed by performing at least some of the queries concurrently, e.g., beginning one or more of the search processes before one or more of the other search processes are completed. In some implementations, all of the multiple queries are initiated to at least begin concurrently. For example, each of the queries are executed by a processor of the client device. The cache memory may store data including content, metadata, body, title, author, heading, category, subtitle, and commentary. The processor can search over this data in the cache memory to identify results that match to the rules indicated by each of the queries.

The client device receives a set of results for each of one or more of the multiple queries (408). In some implementations, the results are received independently from one another. The results associated with a particular query are mutually exclusive or disjoint from results associated with the other queries.

The client device can rank the search results within each set, associated with a particular query. The search results within each set may be ranked according to certain criteria. For example, the certain criteria can include a relevance of results to the user associated with the client device, a context of the search results, and a popularity of the search results for other users.

Then, the client device ranks the results sets associated with each query relative to one another. For example, the client device ranks the results associated with the first query higher than the results associated with the second query. Additionally, the client device ranks the results associated with the third query below the results associated with the second query. Other rankings are also possible and left open to the implementation of the designer.

The client device provides the set of results for each of the one or more of the multiple queries (410). For example, the client device dynamically updates the user interface with the set of search results for each query. As results are newly generated and ranked, the client device can update the user interface with the newly generated results by placing the newly generated results in the ranked location on the display. Since the results associated with each query can be received asynchronously, the client device can update the user interface as search results are generated.

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions encoded on a computer-readable medium for execution by, or to control the operation of, data processing apparatus. The computer readable medium may be a non-transitory computer readable storage medium, a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor 113 and the memory may be supplemented by, or incorporated in, special purpose logic circuitry.

To provide for interaction with a user, embodiments of the invention may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the invention may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the invention, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
receiving, by the one or more computers, a query term;
generating, by the one or more computers, multiple queries based on the query term, wherein the multiple queries are generated to include criteria such that the multiple queries respectively yield mutually disjoint sets of results;
processing, by the one or more computers, the multiple queries in parallel;
receiving, by the one or more computers, a set of results for each of one or more of the multiple queries; and
providing, by the one or more computers, the set of results for each of the one or more of the multiple queries.

2. The method of claim 1, wherein receiving a set of results for each of one or more of the multiple queries comprises:
receiving a first set of results for a first query of the multiple queries; and
receiving a second set of results for a second query of the multiple queries;
wherein providing the sets of results comprises providing the first set of results and the second set of results ranked according to a predetermined priority of the first query with respect to the second query.

3. The method of claim 2, wherein providing the set of results comprises providing the set of results for display in a user interface, the set of results from each query being grouped together, with the groups ordered according to the ranking.

4. The method of claim 1, wherein each of the multiple queries is based on the query term, such that each of the multiple queries includes criteria requiring a match to at least a portion of the query term.

5. The method of claim 1, wherein at least some of the multiple queries have criteria corresponding to different levels of similarity with the query term or different degrees of match with the query term; and
wherein the sets of results are ranked according to the different levels of similarity with the query term or the different degrees of match with the query term.

6. The method of claim 1, wherein receiving a set of results comprises receiving a first set of results for a first query of the multiple queries;
wherein providing the set of results comprises displaying the first set of results;
wherein the method comprises:
after displaying the first set of results, receiving a second set of results for a second query of the multiple queries;
accessing data indicating a predetermined ranking of the second set of results with respect to the first set of results; and
displaying the second set of results at a location determined based on the predetermined ranking.

7. The method of claim 1, wherein the predetermined ranking specifies that results from the second query are ranked higher than results from the first query; and
wherein displaying the second set of results comprises inserting the second set of results above the first set of results that were previously displayed.

8. The method of claim 1, comprising:
obtaining the sets of results for the multiple queries asynchronously with respect to each other; and
providing updated search result information for display in response to receiving each of the sets of results, wherein the sets of results are organized in groups that are ranked based on the respective queries that yielded the sets of results.

9. The method of claim 1, wherein each of the multiple queries includes mutually exclusive criteria, and
wherein processing the multiple queries comprises identifying results for each of the multiple queries in a same data set.

10. The method of claim 1, wherein generating the multiple queries comprises generating a series of queries in which (i) each of the query in the series includes one or more positive criteria indicating a characteristic required to satisfy the query, and (ii) the second and subsequent queries in the series each include one or more negative criteria that exclude the characteristics of the positive criteria of each of the previous queries in the sequence.

11. The method of claim 1, wherein the multiple queries include:
a first query that includes one or more first criteria based on the query term; and
a second query that includes (i) one or more second criteria based on the query term and (ii) a limitation to exclude results that meet the one or more first criteria.

12. The method of claim 11, wherein the multiple queries further comprise a third query that includes (i) one or more third criteria based on the query term, (ii) a limitation to exclude results that meet the one or more first criteria, and (iii) a limitation to exclude results that meet the one or more second criteria.

13. The method of claim 1, wherein at least some of the multiple queries are configured to require different types of matches to the query term, including at least one of an exact match, a partial match, a prefix match with an initial portion of the query term, a suffix match with an ending portion of the query term, a fuzzy match, or a phonetic match.

14. The method of claim 1, wherein at least some of the multiple queries require matching at least a portion of the query term to different portions or fields in a data set.

15. The method of claim 1, wherein processing the multiple queries in parallel comprises running the queries such that sets of results for the multiple queries are received asynchronously independent each other.

16. The method of claim 1, wherein generating multiple queries comprises generating a predetermined number of queries based on a predetermined set of query templates, the query templates each having a predetermined ranking or priority with which to order sets of results responsive to queries derived from the respective query templates.

17. The method of claim 1, comprising:
communicating, by a computing device, with a server system to update contents of a local cache of the computing device; and
generating, by the computing device, an index based on the updated contents of the cache;
wherein processing the multiple queries comprises using the index identify content from the cache that is responsive to the respective multiple queries.

18. The method of claim 1, wherein the receiving the query term, the processing, the generating, the receiving the set of results, and the providing are performed by a mobile computing device.

19. A system comprising:
one or more computers; and
one or more computer-readable media storing instructions that, when executed by the one or more computers, cause the one or more computers to perform operations comprising:
receiving, by the one or more computers, a query term;
generating, by the one or more computers, multiple queries based on the query term, wherein the multiple queries are generated to include criteria such that the multiple queries respectively yield mutually disjoint sets of results;
processing, by the one or more computers, the multiple queries in parallel;
receiving, by the one or more computers, a set of results for each of one or more of the multiple queries; and
providing, by the one or more computers, the set of results for each of the one or more of the multiple queries.

20. One or more non-transitory computer-readable media storing instructions that, when executed by the one or more computers, cause the one or more computers to perform operations comprising:
receiving, by the one or more computers, a query term;
generating, by the one or more computers, multiple queries based on the query term, wherein the multiple queries are generated to include criteria such that the multiple queries respectively yield mutually disjoint sets of results;
processing, by the one or more computers, the multiple queries in parallel;
receiving, by the one or more computers, a set of results for each of one or more of the multiple queries; and
providing, by the one or more computers, the set of results for each of the one or more of the multiple queries.
